(19) United States
(12) Patent Application Publication
(10) Pub. No.: US 2026/0175718 A1
(43) Pub. Date: Jun. 25, 2026

(54) ELECTRIC VEHICLE CHARGER CABLE MANAGEMENT

(71) Applicant: IRONWATT INC., San Jose, CA (US)

(72) Inventor: Ximing WANG, Los Alamitos, CA (US)

(21) Appl. No.: 18/999,216

(22) Filed: Dec. 23, 2024

(51) Int. Cl. B60L 53/18; B60L 53/16

(52) U.S. Cl. CPC B60L 53/18; B60L 53/16

(57) ABSTRACT

An electric vehicle (EV) charger with a charging cable management design that reduces tripping hazard for pedestrians, reduces damages, improves usability, enhances aesthetic and efficiency, etc. The EV charger has an effective way of managing the charging cable by using a detachable mechanism that includes a cable handle installed in the middle portion of the charging cable. The detachable mechanism includes a cable handle and a handle holder that are configured to automatically separate from other each when the user pulls the charging cable away from the charger.

### TECHNICAL FIELD

The technology discussed below relates generally to a charger for electric vehicles and a cable management system of the charger.

### INTRODUCTION

An electric charger for electric vehicles is a device used to supply electric power to recharge the battery of an electric vehicle (EV). These chargers can come in various types and levels, ranging from basic home chargers to fast DC (direct current) chargers found in public charging stations. Level 1 charger is a basic charger that plugs into a standard household outlet (e.g., 120 volts AC). It provides a slow charging rate, suitable for overnight charging. Level 2 charger operates at higher power levels (e.g., 240 volts AC) than a level 1 charger, allowing for faster charging times. Level 2 chargers are commonly installed at homes, workplaces, and public charging stations. DC fast charger (also known as level 3 charger) supplies direct current power directly to the EV's battery, bypassing the vehicle's onboard charger. DC fast chargers can charge EVs much faster than Level 1 and Level 2 chargers, providing significant amounts of power in a short amount of time. Lever 3 chargers are typically found along highways and in public charging networks.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

One aspect of the disclosure provides an electric vehicle (EV) charging system. The EV charging system includes a charger configured to provide power for charging an electric vehicle. The EV charging system further includes a charging cable with a first end connected to the charger and a charging connector connected to a second end of the charging cable. The EV charging system further includes a detachable mechanism configured to releasably support the charging cable. The detachable mechanism includes a cable handle and a handle holder that are configured to automatically separate from other each when a user pulls the charging cable away from the charger.

In one aspect, no physical connection exists between the cable handle and the handle holder when the cable handle and the handle holder are separated.

In one aspect, the cable handle and the handle holder are configured to separate from each other without physical interaction from the user.

In one aspect, the cable handle includes a grip portion, a cable attachment portion, and an anchor portion between the grip portion and the cable attachment portion, and the cable attachment portion is openable to facilitate installation of the charging cable through a gap of the cable attachment portion.

In one aspect, the cable attachment portion includes a first curved portion and a second curved portion that form an opening for receiving the charging cable therein.

In one aspect, a width of the opening of the cable attachment portion is adjustable by changing an extent of overlapping between the first curved portion and the second curved portion.

In one aspect, at least one of the first curved portion or the second curved portion is made of a flexible material.

In one aspect, the cable attachment portion includes a recess that is configured to receive at least a portion of a ratcheting mechanism of a cable tie. In one aspect, the cable attachment portion further includes a groove that is configured to receive a strip portion of the cable tie.

In one aspect, the grip portion forms an angle less than 180 degrees with respect to the anchor portion.

In one aspect, the handle holder includes a base portion, a first support portion extending from a first end of the base portion, and a second support portion extending from a second end of the base station, the cable handle. Respective top surfaces of the first support portion and the second support portion are configured to angle upward to secure the cable handle.

In one aspect, the base portion includes a recess shaped to receive a portion of the anchor portion of the cable handle.

One aspect of the disclosure provides a method of operating an electric vehicle (EV) charging system. The method includes removing a charging connector from a charger configured to provide power for charging an electric vehicle. The charging connector is connected to the charger via a charging cable, A detachable mechanism is configured to releasably support the charging cable. The detachable mechanism includes a cable handle and a handle holder that are configured to automatically separate from other each when a user pulls the charging cable away from the charger. The method further includes pulling the charging cable away from the charger toward the electric vehicle, thereby releasing the cable handle from the handle holder without physical interaction between the user and the cable handle.

One aspect of the disclosure provides a cable management apparatus for an electric vehicle (EV) charger. The apparatus includes a cable handle connected to a charging cable of the EV charger. The apparatus further includes a handle holder configured to support the cable handle on a surface of the handle holder. The surface is inclined, deviating from a horizontal orientation, to prevent the cable handle from sliding out of the handle holder.

In one aspect, the cable handle includes a grip portion, a cable attachment portion, and an anchor portion between the grip portion and the cable attachment portion, and the cable attachment portion is openable to facilitate installation of the charging cable through a gap of the cable attachment portion.

In one aspect, the handle holder includes a base portion, a first support portion extending from a first end of the base portion, and a second support portion extending from a second end of the base portion, respective top surfaces of the first support portion and the second support portion configured to angle upward to secure the cable handle.

In one aspect, the anchor portion has a width greater than a width of an opening space between the first support portion and the second support portion.

In one aspect, the anchor portion has a partially spherical shape.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an exemplary electric vehicle (EV) charger according to some aspects of the disclosure.

FIG. 2 is a diagram illustrating an exemplary cable handle according some aspects of the disclosure.

FIG. 3 is a diagram illustrating an exemplary handle holder according some aspects of the disclosure.

FIG. 4 is a diagram illustrating an example of cable handle and handle support according to some aspects of the disclosure.

FIG. 5 is a flow chart illustrating an exemplary process for operating an EV charger according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements.

A electric vehicle (EV) charger can have one or more charging cables for supplying power to an EV. One end of a charging cable is connected to the charger, and the other end of the charging cable is equipped with a charging connector. Different charging connectors are used for different charging standards, for example, J1772 for AC charging, CCS (Combined Charging System) for both AC and DC charging, CHAdeMO for DC fast charging, NACS (North American Charging Standard or Tesla plug) for AC and DC charging, etc.

For charging an EV, a user retrieves a charging cable from the charger and plugs the charging connector into the charging port of the EV. Once the EV's battery reaches its desired charge level or the user decides to stop charging, the user can disconnect the charging cable from the EV. Then, the cable can be stowed away for future use by the next user. The charging cable needs a sufficient length in order to reach the charging port of the EV that can have various sizes and/or charging port design. Charging cable management is an important aspect of charger designs. Without proper cable management, the charging cable can become tangled, damaged, or pose tripping hazards, especially in public charging locations.

When the charging cable is too long and/or not properly returned to (e.g., stowed, organized, put in order, positioned, arranged) the charger, it can lead to several potential problems. A long, trailing cable can pose a tripping hazard for pedestrians, especially in busy areas such as parking lots or sidewalks. If the charging cable is left lying on the ground or exposed to the elements, it is more susceptible to damage from vehicles driving over it, extreme weather conditions, or accidental impacts. Damage to the charging cable can compromise its functionality and safety. Leaving the cable extended and not returned to the charger can cause inconvenience to other EV users who need to use the charging station. The users may find it difficult to access the charger or may have to maneuver around and/or unwrap the extended tangled cable, leading to delays and frustration. When the charging cable is not properly returned to the charger, it may become twisted, tangled, or pinched, affecting its ability to deliver electricity efficiently to the EV. This can result in slower charging times or interruptions to the charging process. An unattended charging cable left extended from the charger may attract unwanted attention and increase the risk of theft or vandalism. Extended cables that are not organized, tangled in a mess, or lying on the ground can seriously affect the aesthetics and lower the quality of the charging station.

Aspects of the present disclosure way provide an effective charging cable management design for ensuring safety, convenience, and the efficient operation of electric vehicle charging infrastructure, both in private and public settings. An EV charger with the disclosed charging cable management design can reduce tripping hazard for pedestrians, reduce damages, improve usability, enhance aesthetic and efficiency, etc. In some aspects, The EV charger has an effective way of managing the charging cable by using a cable management system that incorporates a cable handle installed in the middle portion of the charging cable. The cable handle enables the charging cable to be easily maneuvered and hung on the charger or a nearby attachment point (e.g., a pole or pedestal supporting the charger), preventing the cable from lying on the ground.

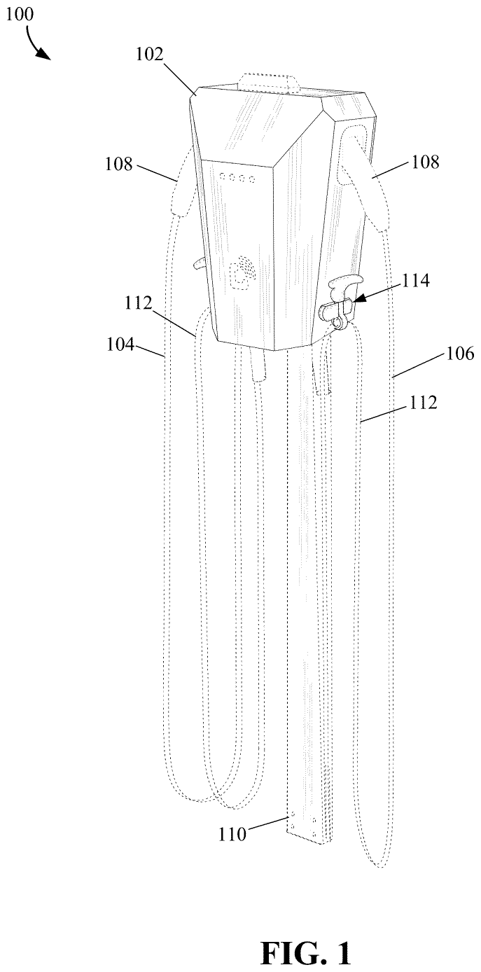

FIG. 1 is a diagram of an exemplary EV charger 100 according to some aspects of the disclosure. The EV charger 100 can include various components that work together to provide power to charge an EV's battery. The EV charger 100 can be housed in a housing 102 (e.g., weather-resistant enclosure), which can be installed indoors or outdoors. The housing can protect the internal components from environmental factors such as rain, dust, and extreme temperatures. Inside the housing, power electronics components (now shown) supplies and/or converts the alternating current (AC) from the power grid into the suitable AC or DC current used to charge the EV's battery. These components ensure efficient power supply and delivery to the vehicle.

The EV charger 100 can be equipped with one or more charging cables (e.g., first charging cable 104 and second charging cable 106) that interface with the EV's charging port. The charging connector 108 may vary depending on the charging standard and region, such as Type 1 (J1772 ), Type 2 (IEC 62196), CCS, CHAdeMO, or NACS (Tesla) connector. The charging cable is typically flexible and durable, designed to withstand frequent use and varying weather conditions. In some examples, the EV charger 100 may have a user interface to enable EV drivers to interact with the charger. In some examples, the user interface may consist of an LCD screen, touchscreen display, and/or LED indicators that provide information about the charging process, such as charging status, power output, and charging duration. In some examples, the EV charger may feature RFID readers or keypads for authentication and payment processing. In some examples, the EV charger can be installed on a pole 110 (alternatively on a pedestal or wall-mounted bracket. The mounting hardware ensures that the charger is securely anchored in place and positioned for easy access by EV drivers.

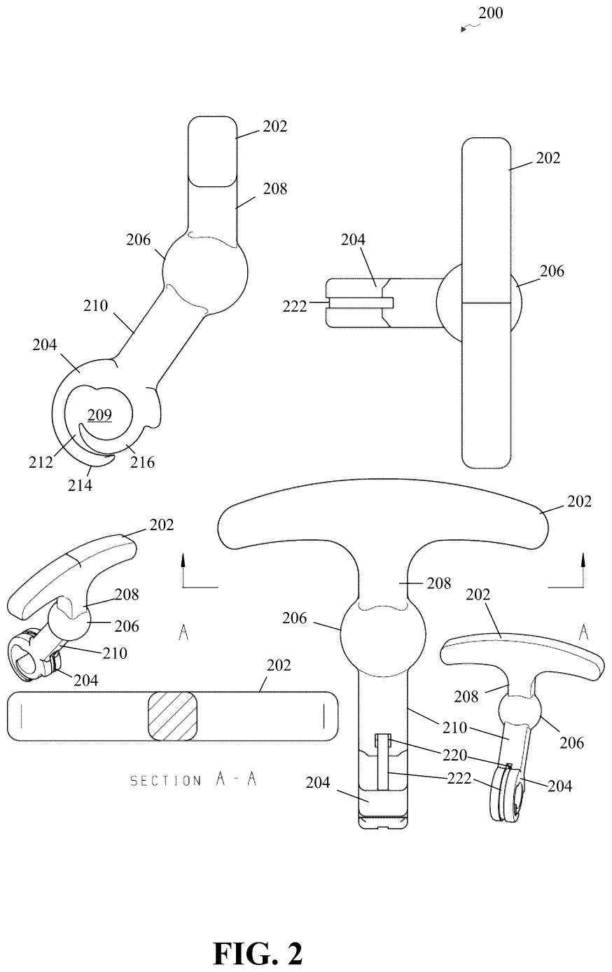

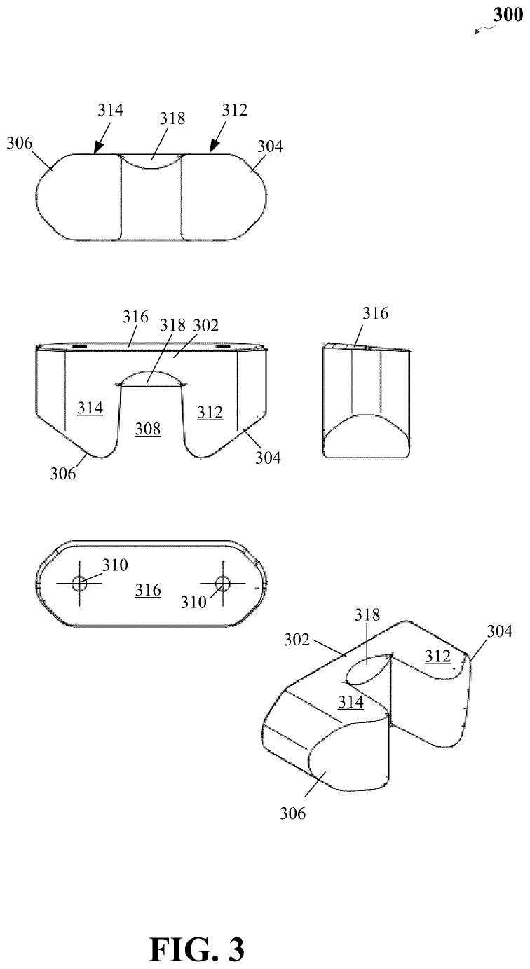

In some aspects, a middle portion 112 of the charging cable can be hung on the charger housing or a nearby position (e.g., a pole, a wall, pedestal, etc.) using a detachable mechanism 114 that includes a cable handle (e.g., cable 200 in FIG. 2) tied to the cable and a handle holder (e.g., handle holder 300 in FIG. 3). For example, the cable handle can be installed at or near the middle portion of the charging cable and serves as a convenient grip point, facilitating easy handling and storage of the charging cable after charging. The handle holder can be removably attached to the charger's housing or a nearby attachment point (e.g., on a pole, a wall, pedestal, etc.). To start the charging process, the user grasps the charging connector and gently pulls the charging connector and cable towards the EV. The cable handle is designed to automatically release from the handle holder withing any user involvement. That is, the detachable mechanism 114 allows the cable handle and the handle holder to separate from each other without requiring physical interaction from the user. There is no physical connection between the cable handle and the handle holder once they are separated.

After charging, the user can simply grasp the cable handle and return the cable handle to the handle holder such that the middle portion of the charging cable is suspended above the ground. By suspending the charging cable off the ground using the cable handle and handle support (together constituting the detachable mechanism 114), tripping hazards as well as wear and tear on the charging cable can be reduced. Moreover, the charging area can remain clutter-free, promoting a clean and organized charging environment.

FIG. 2 is a diagram illustrating various views of an exemplary embodiment of a cable handle 200 according to some aspects of the disclosure. FIG. 3 is a diagram illustrating various views of an exemplary embodiment of a handle holder 300 according to some aspects of the disclosure. In FIGS. 2 and 3, the specific dimensions and shapes of the cable handle 200 and handle holder 300 are illustrative examples. The cable handle 200 and handle holder 300 can have other dimensions, proportions, and shapes in other contemplated embodiments.

In one example, the cable handle 200 and handle holder 300 can be the cable handle and handle holder shown and described above in relation to FIG. 1. The cable handle 200 is designed to be easily released from the handle holder 300 without user involvement when the user pulls the charging cable or connector away from the charger. The cable handle can be made of a durable material (e.g., plastic, rubber, metal, etc.) that can withstand frequent use.

Referring to FIG. 2, the cable handle 200 has a grip portion 202, a cable attachment portion 204, and an anchor portion 206. The anchor portion is the part of the cable handle that is at least partial received within or hung on the handle holder, ensuring stability and preventing the cable handle from slipping out unintentionally when the cable is not in use. The anchor portion may have a spherical shape (e.g., completely or partially ball-shaped). The grip portion is connected to the anchor portion by a first extension 208, and the cable attachment portion is connected to the anchor portion by a second extension 210. The first extension and the second extension can be equal or different in length in various designs. The anchor portion has a width (e.g., diameter) greater than the first extension and/or second extension.

The cable attachment portion 204 is designed to wrap or loop around the charging cable and be secured on the cable (e.g., cable 104/106). To that end, the cable attachment portion can form an oval or circular opening 209 that can accommodate the size (e.g., diameter) of the charging cable. The cable attachment portion is designed to be openable to facilitate the installation of the charging cable. For example, the cable attachment portion can be opened to provide a gap 212 that is wide enough to allow the charging cable to pass through during installation. In this example, the cable attachment portion has a first curved portion 214 and a second curved portion 216 that together form the opening 209 (e.g., an oval or circular opening) for receiving the charging cable therein. In one example, the first curved portion can at least partially overlap with the second curved portion. At least one of the first curved portion and the second curved portion is made of a flexible material (e.g., rubber, plastic, etc.) that can be pulled or bent away from the other curved portion to facilitate the installation of the cable. A width or diameter of the opening of the cable attachment portion is adjustable by changing an extent of overlapping between the first curved portion and the second curved portion.

During the installation of the cable handle on the charging cable, there is no need to cut or disassemble the cable already connected on the charger. The cable attachment portion can be adapted to cables of different diameters within a certain range. In some aspects, the cable attachment portion can be secured on the charging cable using a cable tie or the like. In some aspects, a ratcheting mechanism of the cable tie can be stored (at least partially) in a specially designed recess area 220 (e.g., recess, indentation, cavity, etc.), avoiding sharp cuts or edges that can injury the user's hands, and making the product look more fashionable and desirable. In some aspects, the cable attachment portion can have a groove 222 or slot that is configured to receive the strip portion of the cable tie therein.

In some aspects, the grip portion 202 features a deliberate bend or angle in its design. For example, the first extension 208 forms an angle (e.g., less than 180 degrees) with respect to the anchor portion 206. By introducing this angle, it is easier for the user to access the grip portion, especially when the cable handle is placed in the handle holder. Further, the user can grip the cable handle without bending their wrists excessively, minimizing strain during use.

Referring to FIG. 3, the handle holder 300 has a base portion 302, a first support portion 304, and a second support portion 306. The first support portion extends from a first end of the base portion, and the second support portion extends from a second end of the base station. The first support portion is spaced apart from the second support portion to form an opening space 308 such that the second extension of the cable handle can extend between the first support portion and the second support portion when the cable handle is placed on the handle holder. A width of the opening space 308 is less than the width of the anchor portion so that the anchor portion can rest on the first support portion and the second support portion without falling through the opening space 308.

The handle holder can be installed on the charger's housing or a nearby attachment point and secured for example using suitable fasteners. The fasteners can pass through corresponding holes (e.g., holes 310) of the base portion.

After installation, the top surfaces 312, 314 of the first support portion and second support portion are angled upward such that when the cable handle is placed on the handle holder (on the first support portion and the second support portion), the cable handle can rest securely on the handle holder. The surfaces are angled or inclined, deviating from a horizontal orientation, to create a slope or incline. This tilt is intentionally designed to prevent the cable handle from sliding or falling out of the handle support. The angle of the tilt may vary depending on the specific application and the size and weight of the handle support. The tilted surface features a gradient that directs the cable handle towards a lower point of the handle holder, minimizing the risk of cable handle rolling or sliding off. For example, an angle formed between a back surface 316 of the base portion and the top surface 312/314 of the first/second support portion can be greater than 90 degrees (e.g., 95 degrees). In some aspects, the base portion can have a recess 318 (e.g., concave or hollowed-out area) that is shaped to receive a portion of the anchor portion of the cable handle.

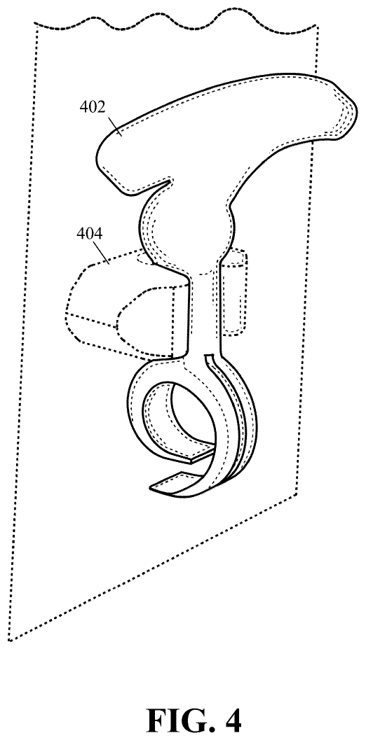

FIG. 4 illustrates an exemplary design of the cable handle and handle support according to some aspects of the disclosure. In this example, the cable handle 402 is hung on the handle support 404.

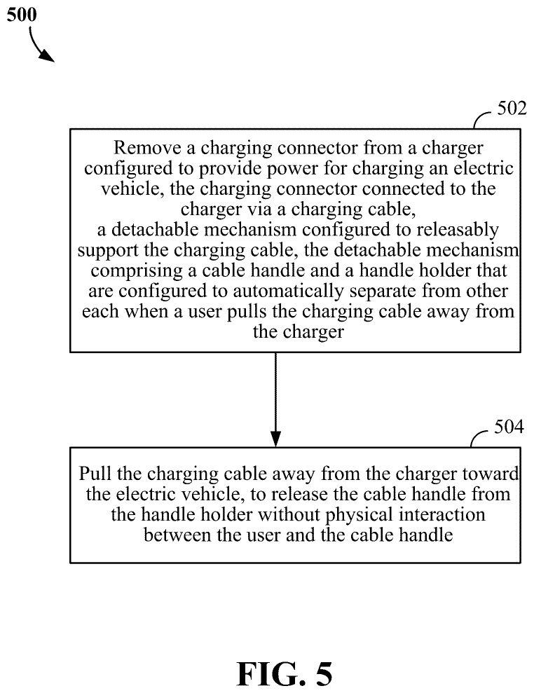

FIG. 5 is a flow chart illustrating a method of operating the EV charger according to some aspects of the disclosure. For example, the method 500 can be operated using the EV charger 100 as described above in relation to FIGS. 1-4. At 502, a user removes a charging connector from a charger configured to provide power for charging an electric vehicle. The charging connector is connected to the charger via a charging cable. A detachable mechanism is configured to releasably support the charging cable. The detachable mechanism includes a cable handle and a handle holder that are configured to automatically separate from other each when the user pulls the charging cable away from the charger. At 504, the user pulls the charging cable away from the charger toward the electric vehicle, to release the cable handle from the handle holder without physical interaction between the user and the cable handle.

The above-described thoughtful design EV charger cable management system not only enhances user experience but also contributes to the longevity of the charging equipment by reducing the risk of cable damage and improving overall safety for EV owners and pedestrians alike. Additionally, the intuitive nature of the cable management system makes it user-friendly for individuals of all ages and abilities, further enhancing accessibility to electric vehicle charging infrastructure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-5 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5 may be configured to perform one or more of the methods, features, or steps described herein.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An electric vehicle (EV) charging system, comprising:
a charger configured to provide power for charging an electric vehicle;
a charging cable with a first end connected to the charger;
a charging connector connected to a second end of the charging cable; and
a detachable mechanism configured to releasably support the charging cable, the detachable mechanism comprising a cable handle and a handle holder that are configured to automatically separate from other each when a user pulls the charging cable away from the charger.

2. The EV charging system of claim 1, wherein no physical connection exists between the cable handle and the handle holder when separated.

3. The EV charging system of claim 2, wherein the cable handle and the handle holder are configured to separate from each other without physical interaction from the user.

4. The EV charging system of claim 1, wherein the cable handle comprises a grip portion, a cable attachment portion, and an anchor portion between the grip portion and the cable attachment portion, and
the cable attachment portion is openable to facilitate installation of the charging cable through a gap of the cable attachment portion.

5. The EV charging system of claim 4, wherein the cable attachment portion comprises a first curved portion and a second curved portion that form an opening for receiving the charging cable therein.

6. The EV charging system of claim 5, wherein a width of the opening of the cable attachment portion is adjustable by changing an extent of overlapping between the first curved portion and the second curved portion.

7. The EV charging system of claim 5, wherein at least one of the first curved portion or the second curved portion is made of a flexible material.

8. The EV charging system of claim 4, wherein the cable attachment portion comprises a recess that is configured to receive at least a portion of a ratcheting mechanism of a cable tie.

9. The EV charging system of claim 8, wherein the cable attachment portion further comprises a groove that is configured to receive a strip portion of the cable tie.

10. The EV charging system of claim 4, wherein the grip portion forms an angle less than 180 degrees with respect to the anchor portion.

11. The EV charging system of claim 4, wherein the handle holder comprises a base portion, a first support portion extending from a first end of the base portion, and a second support portion extending from a second end of the base portion,
respective top surfaces of the first support portion and the second support portion configured to angle upward to secure the cable handle on the handle holder.

12. The EV charging system of claim 11, wherein the base portion comprises a recess shaped to receive a portion of the anchor portion of the cable handle.

13. A method of operating an electric vehicle (EV) charging system, comprising:
removing a charging connector from a charger configured to provide power for charging an electric vehicle, the charging connector connected to the charger via a charging cable,
a detachable mechanism configured to releasably support the charging cable, the detachable mechanism comprising a cable handle and a handle holder that are configured to automatically separate from other each when a user pulls the charging cable away from the charger; and
pulling the charging cable away from the charger toward the electric vehicle, to release the cable handle from the handle holder without physical interaction between the user and the cable handle.

14. A cable management apparatus for an electric vehicle (EV) charger, comprising:
a cable handle connected to a charging cable of the EV charger; and
a handle holder configured to support the cable handle on a surface of the handle holder,
the surface being inclined, deviating from a horizontal orientation, to prevent the cable handle from sliding out of the handle holder.

15. The cable management apparatus of claim 14, wherein the cable handle comprises a grip portion, a cable attachment portion, and an anchor portion between the grip portion and the cable attachment portion, and
the cable attachment portion is openable to facilitate installation of the charging cable through a gap of the cable attachment portion.

16. The cable management apparatus of claim 15, wherein the handle holder comprises a base portion, a first support portion extending from a first end of the base portion, and a second support portion extending from a second end of the base portion, respective top surfaces of the first support portion and the second support portion configured to angle upward to secure the cable handle on the handle holder.

17. The cable management apparatus of claim 16, wherein the anchor portion has a width greater than a width of an opening space between the first support portion and the second support portion.

18. The cable management apparatus of claim 16, wherein the anchor portion has a partially spherical shape.
